(19) United States
(12) Patent Application Publication
(10) Pub. No.: US 2018/0232404 A1
(43) Pub. Date: Aug. 16, 2018

(54) SELF-RECOMPOSING PROGRAM TO TRANSFORM DATA BETWEEN SCHEMAS

(71) Applicant: CA, Inc., Islandia, NY (US)

(72) Inventor: Bilal M. Bhatti, Islandia, NY (US)

(21) Appl. No.: 15/433,449

(22) Filed: Feb. 15, 2017

(51) Int. Cl. G06F 17/30; G06F 17/27; G06F 9/54

(52) U.S. Cl. CPC G06F 17/30294; G06F 17/30958; G06F 9/541; G06F 17/2705; G06F 17/30569; G06F 17/30011

(57) ABSTRACT

Provided is a process of transforming data exchanged between a diverse set of target application program interfaces (APIs) having different respective external data schemas and an identity management system (IMS) database having an internal data schema with programs that adaptively expand their own set of instructions based on operation of the programs on API or IMS database responses.

### BACKGROUND

### 1. Field

The present disclosure relates generally to computing and, more specifically, to exposing a self-recomposing program to transform data between schemas.

### 2. Description of the Related Art

Recently, many software applications have migrated to the cloud. Often, user-facing and back-end software applications execute on remote computer systems hosted by various third parties. Examples include productivity suites, calendaring applications, email, document management platforms, enterprise resource planning applications, project management applications, and various databases.

Frequently, these applications support programmatic access (e.g., to retrieve data, write data, delete data, or execute other commands) via an application-program interface (API). In many cases, these different network-accessible applications exchange data using different data schemas, or blueprints for how data is to be organized and labeled, often with different data normalizations and different name spaces. Often, differences in data schemas make it difficult to develop applications that tie-together diverse sets of network-accessible applications, as each application, in essence, speaks a different language.

Many existing techniques for translating between data schemas are not well suited for expected trends in distributed applications. Increasing amounts of applications are expected to move to the cloud, giving rise to increasing amounts of data schemas to target with translation tools. And data schemas are expected to change over time, as new versions are introduced, and new versions are expected to be released with increasing frequency as developers adopt rapid update cadences to release new features and address security issues. Translation tools that accommodate these changes are expected to become overly complex and unmanageable with existing computing techniques.

### SUMMARY

The following is a non-exhaustive listing of some aspects of the present techniques. These and other aspects are described in the following disclosure.

Some aspects include a process of transforming data exchanged between a diverse set of target application program interfaces (APIs) having different respective external data schemas and an identity management system (IMS) database having an internal data schema with programs that adaptively their own set of instructions expand based on operation of the programs on API or IMS database responses, the process including: obtaining, with one or more processors, a document containing initial instructions to transform data entering or exiting an IMS, wherein: the transformation is between an internal data schema of an IMS database and a first data schema of a first API of a first network-accessible application that provides resources to users, and the IMS database is configured to store records mapping users to records of user accounts with a plurality of different network-accessible applications including the first network-accessible application; loading, with one or more processors, the initial instructions contained by the document into a data structure representing the initial instructions in program state; executing, with one or more processors, the instructions loaded into program state, wherein executing the instructions comprises: determining, based on data obtained from the first API or the IMS database, that a condition specified in at least some of the instructions obtains; in response to the determination, adding an additional instruction to the data structure in program state; and executing the additional instruction; at least in part by executing the initial instructions and the additional instruction, transforming, with one or more processors, data between the internal data schema of the IMS database and the first data schema of the first API; and storing, with one or more processors, the transformed data in the IMS database or sending, with one or more processors, the transformed data to the first network-accessible application via the first API.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a flow chart of an example of a process to transform data between schemas in accordance with some embodiments of the present techniques;

FIG. 2 is a block diagram of a physical and logical architecture of an example of an identity management system that exemplifies the types of applications that may benefit from the techniques of FIG. 1; and

FIG. 3 is a block diagram of an example of a computer system by which the above techniques may be implemented.

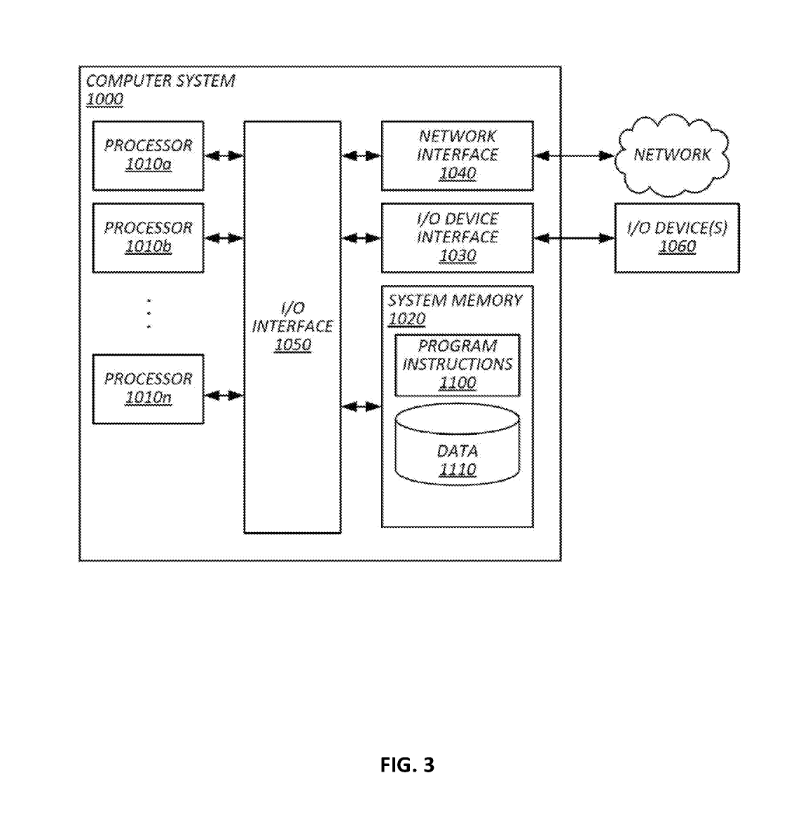

While the disclosed techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the disclosed techniques to the particular form disclosed, but to the contrary, the intention is to cover all modifications, equivalents, and alternatives falling within the spirit and scope of the present disclosed techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of computer science. Indeed, the inventors wish to emphasize the difficulty of recognizing those problems that are nascent and will become much more apparent in the future should trends in the distributed workload platform field continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

As noted, traditional programs written to translate between data schemas are expected to become unmanageable as developers attempt to integrate with increasing numbers of network-accessible applications having diverse sets of data schemas. This is because, in part, many existing program languages maintain strict separation between data and code. As a result, these languages are often not well suited for specifying operations in which data values can lead to highly variable conditional branches, as often arise when data schemas vary or are generally complex in a given instance. Code often tends to expand when handling the various cases, making it difficult to write and reason about the code. This problem is particularly acute when interfacing with diverse arrays of third party APIs that might respond in diverse ways or impose sequential constraints in various conditional branches.

To mitigate these issues or others below (or those issues that are implicit and apparent to readers of ordinary skill in the art), some embodiments provide for a way of writing translation programs that are more flexible, resulting in more code-reuse and reducing complexity relative to traditional systems. Some embodiments implement a domain specific language in JavaScript™ object notation (JSON) where both the data and program instructions are encoded in JSON. In some embodiments, operation on data may cause the set of instructions to change itself, e.g., to add instructions (which is distinct from merely activating a set of instructions already explicit in program code). To facilitate self-adjustment, some embodiments may explicitly (i.e., in the program code in the format in which it is composed and obtained) encode an abstract syntax tree (AST) in a JSON document, and as the instructions are executed, some of those instructions may cause the AST to be amended, creating code for exploring additional conditional branches.

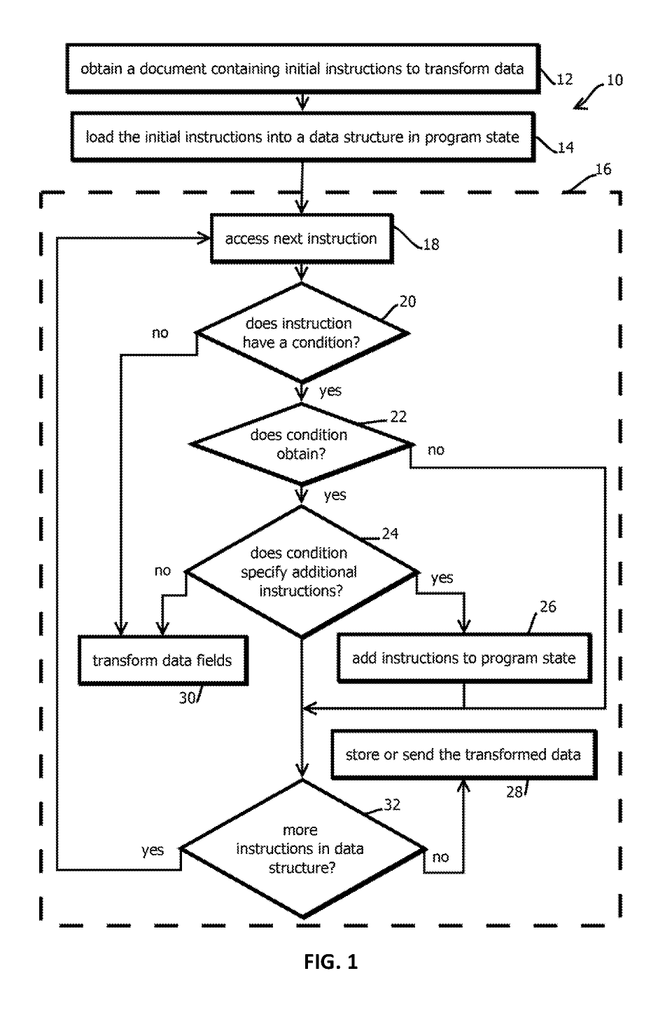

FIG. 1 is a flowchart of an example of a process 10 that may mitigate some of the above-described problems, along with other issues discussed below and various problems that will be apparent to those of skill in the ordinary skill in the art. In some embodiments, the process 10 may transform data exchange between a diverse set of application program interfaces, each having different external data schemas, and an internal data schema, for instance, used by a system executing the process 10 in service of various applications that aggregate data from various APIs or exercise control via various APIs. (The terms “internal” and “external” used in this sense merely contrast a schema over which the developer has control in their own system with those APIs in other systems over which the developer does not have control, e.g., either because of legacy commitments or because they are provided by third parties.)

In some embodiments, the data transformations may be specified by relatively concise program code in a domain-specific homoiconic programming language. In some embodiments, the program code may expand the program code to add additional instructions to itself in the course of executing, in some cases based on the result of various conditional branches specified within the program code. Further, in some embodiments, the program code may be obtained in a format that makes an abstract syntax tree of the program code explicit, such that the program code need not be parsed to form at least one type of abstract syntax tree (which should not be read to suggest that additional parsing is not performed, or the additional transformations into other formats of of abstract syntax trees are not performed). In some cases, obtaining the program code initially in this hierarchical tree format facilitates expansion of the program code and is expected to reduce run times by obviating additional parsing steps. It should be noted, though, that various independently useful techniques are described, and not all of these or the other benefits discussed herein are afforded by all embodiments, which is not to suggest that any other feature described herein may not be omitted in some cases.

In some embodiments, the process 10, the other processes described herein, and code for implementing the functionality described herein, may be encoded as instructions in a tangible, non-transitory, machine-readable medium, such that when the instructions are read from the medium and executed by one or more processors, the functionality and processes described herein are effectuated. In some embodiments, notwithstanding use of the singular term “a medium,” the instructions may be distributed among multiple computing devices, with different computing devices running different subsets of the instructions, in some cases with various instructions executing concurrently, or in some cases with some of the instructions executing serially. Even in these scenarios, the program code is referred to as being stored on “a medium,” singular.

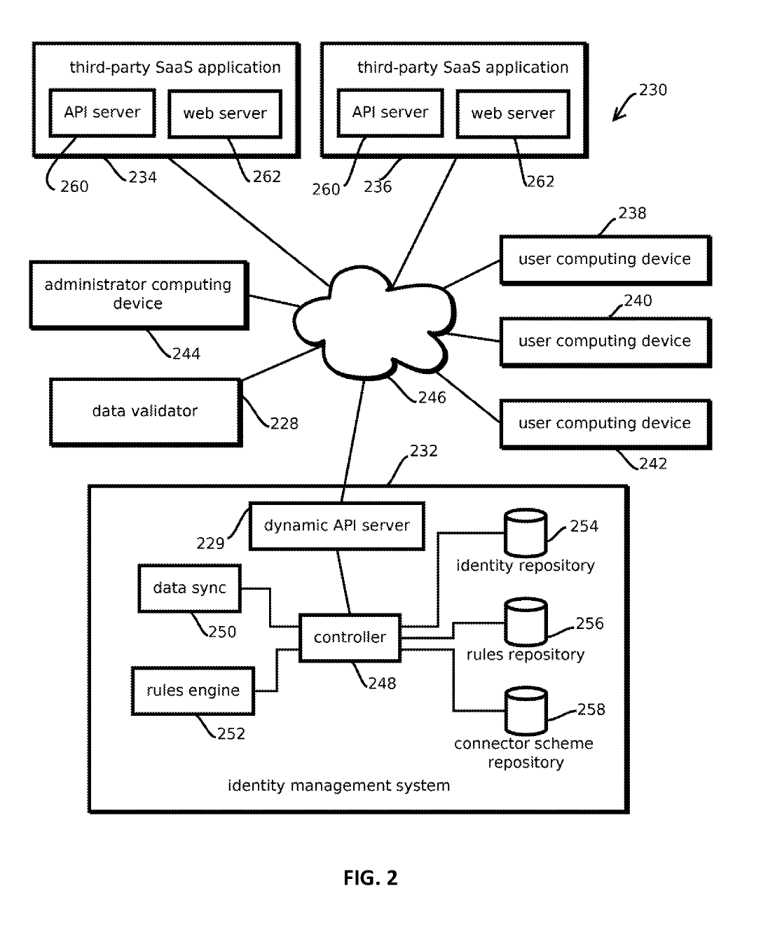

In some embodiments, the process 10 may be executed by an application (referred to as a “source application”) that interfaces with a diverse array of application program interfaces of other applications (referred to as “target applications” to distinguish from the source application) having differing data models represented in different data schemas. Such applications are expected to occur in a wide variety of different use cases, including enterprise resource management systems, customer relationship management systems, document management systems, healthcare data processing systems, data analytics systems, and the like, to name just a few examples where different APIs may be tied together. An illustrative example is described below with reference to an identity management system shown in FIG. 2, which is expected to otherwise present a particularly accuse case of many of the issues mitigated by some embodiments of the present techniques. It should be emphasized, though, that embodiments are not limited to this use case, which is not to imply that any other feature is limiting.

In some embodiments, the process 10 may begin with an event that initiates an exchange of data between the source application executing the process 10 and one or more target APIs (e.g., via a network). In some cases, the exchange may be an inbound exchange of data, where an API request is sent to the target API by the source application, and a response is received with inbound data by the source application. In some cases, that inbound data may be transformed into a format suitable for a data schema of the source application executing the process 10, referred to herein as an internal data schema. In some cases, data may be outbound, for example, in the form of a query response from a database of a source application executing the process 10 that is being sent to a remote target application via an API (e.g., and a network) and is transformed into a format consistent with a data schema of that remote application, referred to as an external data schema. In some embodiments, the process 10 may be executed in the course of a routine that causes data to flow in both directions, resulting in two-way translation.

In the identity management system example, some embodiments of the process 10 may be initiated upon a determination that records in the identity management system are to be reconciled, for example, synchronized, with corresponding records in one or more third-party software-as-a-service (SaaS) applications having accounts managed with the identity management system. For example, a user at a company may be transitioned into a new role at the company, for instance, being promoted to manager in a particular division, and some embodiments may determine based on their new role and one or more of the policies described below, that some of the SaaS accounts of the user should be terminated, some of the SaaS accounts associated with the user should be adjusted (e.g., to add access to additional resources hosted by the SaaS provider), and additional SaaS accounts should be created for the user in accordance with the user's new role. In some cases, each of these changes may be propagated to an internal database of the identity management system.

Some embodiments may then execute the process 10 to effectuate those changes in a plurality of different target SaaS applications via respective APIs. In this scenario, the various SaaS applications may have different data models from one another and relative to the internal database, and those data models be embodied with different data schemas. These differences can range from different names for the same fields (like “email” versus “email address”) to different database normalizations of the data (e.g., data in third normal form versus non-third-normal forms). As a result of these differences, the data often cannot simply be transmitted in the form in which it is obtained from one system to the other and loaded directly into their respective data repositories (e.g., relational databases, graph databases, document databases, and the like). Rather, some embodiments may transform the data into a format suitable for the receiving data repository, either external or internal, depending on the direction of data flow. And as noted above, particularly in the identity management system context, these transformations can be relatively complex and diverse with various and numerous third-party SaaS applications being a managed and different versions of different APIs of those respective SaaS applications being used.

In another example in the context of an identity management system, some embodiments may receive inbound data from a plurality of different APIs of different SaaS applications in the course of initializing an identity management system for a new enterprise. For example, a given company may have more than 10,000 employees with various subsets of those employees having accounts with more than 50 different SaaS applications and different configurations of the different SaaS application accounts depending upon employee roles. When configuring a new instance of the identity management system, some embodiments may ingest records describing those accounts from each of the different SaaS applications and populate an internal database. In the course of this operation, some embodiments may perform the process 10 to transform the data from the different external formats into a format suitable for a data schema of a database of the identity management system.

Data may be exchanged over a network (e.g., the Internet) between SaaS applications and the identity management system in a variety of different formats with a variety of different protocols. In some cases, the SaaS applications expose a representational state transfer (REST)-based API or a or simple object access protocol (SOAP) API, and the data is exchanged in the form of a serialized hierarchical data format like, JSON or extensible markup language (XML) that is sent or received in the context of a hypertext transport protocol (HTTP) request, like a GET request or a POST request. In some cases, the process 10 may be executed to transform data received via one of these requests or to transform data into a format suitable to be sent and ingested by a target API in one of these requests.

In some embodiments, the process 10 begins with obtaining a document containing initial instructions to transform data, as indicated by block 12. In some cases, the document is a text file (e.g., encoded in Unicode or ASCII) in a hierarchical serialized data format, like XML or JSON. In some embodiments, the document is a program composed by a developer in the format in which it was composed, i.e., in source-code format. The document may contain a plurality of (and often more than 50) instructions that indicate how to transform data from an internal representation in an internal data schema to an external representation in a target external data schema, for instance, associated with a target API of a target SaaS application. In some embodiments, the document is a program with instructions to transform data in the opposite direction, or some embodiments may include instructions to transform data in both directions.

In some embodiments, the document contains a relatively large number of instructions, corresponding to a relatively large number of fields being processed in the transformations, for instance, more than 20 instructions for more than 20 fields, and in many commercially relevant use cases, more than 100 instructions from more than 50 different fields of data, with branching instructions that can expand the program to arbitrarily large sets of instructions.

In some embodiments, the document is maintained as a file in persistent storage that retains the document even in the absence of power. In some cases, the documents may take other forms, for example, forms other than that of a text file. In some cases, the documents may be stored as a set of entries in a relational database, for example. In some embodiments, the document may contain an ordered set of instructions that are executed in the sequence specified, or in some cases, some or all of the instructions may be unordered or executed in different sequences from that in which the instructions are listed.

In some embodiments, the document may explicitly express (i.e., in source-code format) the instructions in a hierarchical format, like in a tree format, such as an abstract syntax tree. This is in contrast to many forms of program code where the program code must be parsed by a parser into an abstract syntax tree from the format in which the program code is stored. Some embodiments may explicitly arrange the data in the tree format in the document. This is expected to expedite operations by avoiding the need to parse data into an abstract syntax tree (though embodiments are consistent with additional parsing and transformations, which is not to suggest that any other feature may not also be omitted). Further, this is expected to facilitate manipulation of the program represented in the document by the program itself as the program is and executed, as the AST format is more readily self-manipulated than other forms of source code—though embodiments are not limited to AST-format-source-code, which is not to imply that any other feature may not be also varied.

The term “initial instructions” is used to refer to instructions expressly encoded in the document to distinguish those instructions added to the program as a result of the program executing. As noted, as the program is executed, in some embodiments, the program may add additional instructions to itself, evolving based on changes in program state. In some cases, the program may be characterized as being expressed in a homoiconic programming language in which the data the program operates upon includes the program itself. Examples are described below.

An example of the contents of the type of document that may be obtained with the operation of block 12 follows:

```
“in” : {
  “properties” : {
    “displayName” : {
      “default” : “SaaS-Co Apps”
    },
    “username” : {
      “expression” : “target.primaryEmail”
    },
    “givenName” : {
      “expression” : “target.name.givenName”
    },
    “familyName” : {
      “expression” : “target.name.familyName”
    },
    “email” : {
      “expression” : “target.primaryEmail”
    },
    “orgunit” : {
      “properties” : {
        “self” : {
          “lookup” : {
            “targetEntity” : “orgunit”,
            “using” : “target.orgUnitPath”,
            “output” : “found.graph”
          }
        }
      }
    },
    “changePasswordAtNextLogin” : {
        “expression”: “target.changePasswordAtNextLogin”
    },
    “isAdmin” : {
      “expression” : “target.isAdmin”
    },
    “isDelegatedAdmin” : {
      “expression” : “target.isDelegatedAdmin”
    },
    “isMailboxSetup” : {
      “expression” : “target.isMailboxSetup”
    },
    “syncStatus” : {
      “rule” : {
        “when” : [
            {
              “eq” : {
                “path” : “target.suspended”,
                “value” : true
              }
            }, {
              “yield” : {
                “default” : “DISABLED”
              }
            }, {
              “yield” : {
                “default” : “COMPLETED”
              }
            }
        ]
      }
    }
  }
}
```

The above example is a JSON example of a document containing initial instructions to transform data. As in this example, in some embodiments, the document may be arranged hierarchically, for example in a collection of lists (e.g., collections of items) and dictionaries (items paired with a “key” that indexes the item) that is hierarchical (e.g., where the item is itself a dictionary or list, giving rise to a lower level of the hierarchy). Thus, in some cases, the dictionaries may be key-value pairs, for instance, the key of “display_name” paired with a value that takes the form of another dictionary having a key of “default” paired with a value of “SaaS-Co Apps.” In some cases, the dictionary keys may be entities in a namespace of the data schema to which the translation is outputting, for instance, either internal or external.

In some cases, the dictionary values may be instructions to extract and otherwise transform data from a source into the appropriate value for the specified key. In some cases, this may take the form of a query, like a query language that selects nodes in a hierarchical serialized data format, like XML or JSON. For example, the query “target.name.familyName” may select a root node of a JSON document corresponding to the target, a node under that root node corresponding to the name, and a node under that node corresponding to the familyName field. Thus, a query may specify a path through a hierarchical document to a specific entry or set of entries.

In some cases, these queries may be designated with the reserve term “expression.” Some embodiments may produce an output document in which the key listed is paired with the result of the expression being evaluated, like a query result. In some cases, this output document may also be in a hierarchical serialized data format, for instance with the key of “familyName” paired with the value of “Smith,” in a string of text like [“family name”: “Smith”]. Thus, one type of instruction may map a key-value in a namespace of an output data schema to an expression in the form of a query that returns the appropriate value from data in an input data schema. Some embodiments may perform additional transformations on the query response, for instance, reformatting dates, addresses, and the like, assigning values to variables based on query responses, validating data, etc.

In some embodiments, as shown above, the document may contain instructions that have conditional branches. In some cases, these may be designated with the “rule” reserved term, like under the value “syncStatus” above. In some cases, instructions may include an operate, like the “eq” operator, that indicates whether operands should be determined to be equal or not. Further, some embodiments may associate these operators with operands, like the two values for which the quality is to be evaluated, like whether the value returned by the query corresponding to “path” is equal to the value of true.

In some cases, a hierarchical arrangement of operators and operands may be explicitly stated in the document, for instance with the operator of “eq” serving as a key in a dictionary, and the operands serving as values for that key, in this case the “path” and the “value” dictionary entries in a dictionary that itself serves as the value of the “eq” key.

In some embodiments, the document may have instructions that specify queries into an internal database, like the “orgunit” instruction above. In some cases, this query may be into a graph database having the properties described below with reference to FIG. 2. In some embodiments, results of a query or other instruction may yield a set (e.g., a plurality) of results that each cause a corresponding instruction to be added to the instructions in the document, as described below, like in instruction for each responsive orgunit returned by a query, as discussed below.

In some embodiments, each external data schema may have a respective document having a schema-specific translation program, and some embodiments may select among a plurality of such documents to obtain the document pertaining to the schema for which translation is being performed. In other cases, such documents may be consolidated, e.g., with a single document that contains code to translate for multiple external data schemas. In some cases, the document is formed from a plurality of documents based on one document importing instructions from another document and overriding subsets of those instructions, in some cases with inheritance and polymorphism.

Next, some embodiments may load the initial instructions into a data structure in program state, as indicated by block 14. In some embodiments, this may include parsing the document to read into random access memory a representation of the hierarchy in a tree expressly stated in the document. In some embodiments, the data structure may take the form of an object in an object oriented programming model. For instance, in some cases the object may have attributes that are themselves objects in a lower level of a hierarchy. For example, an object of “givenName” may have an attribute of “expression” which itself has an attribute (or method) of the listed query. In another example, the data structure may be an arrangement of dictionaries and lists specified by the document in a hierarchical arrangement (e.g., with lists or dictionaries serving as values for a given key in a dictionary, and with lists or dictionaries serving as items in a list). In some embodiments, the data structure may be various forms of associative arrays (which is not to imply that the preceding are not also forms of associative array), like a graph, such as a tree, or a linked list. In some cases, program state is held in dynamic memory, for instance, in a portion of dynamic memory allocated to a process executing the process 10 by an operating system, or in some cases, some or all of program state may be committed to persistent memory.

Next, some embodiments may execute the initial instructions loaded into the data structure, as indicated by block 16. In some cases, the instructions may be executed serially, or some embodiments may execute some or all of the instructions concurrently, for instance, by assigning different subsets of the instructions to different computing devices, and instructing those different computing devices to execute the respective subsets and return results.

In some cases, executing the initial instructions include accessing a next instruction, as indicated by block 18. In some embodiments, the data structure may include a plurality of instructions arranged in a hierarchy, and some embodiments may access a next instruction by performing a traversal of that hierarchy, for instance, a depth-first traversal or a breadth-first traversal. In some embodiments, the next instruction may be identified and executed through a recursive process. For example, some embodiments may include a function that takes as an argument the data structure, and that function may identify a next instruction, cause that next instruction to be executed (e.g., execute the instruction itself or assign it to another function or process), and call itself with the data structure as an argument in a new state indicating that one of the instructions has been executed or scheduled to be executed. In some cases, this recursive process may include adding additional instructions to the data structure with the technique described below, before calling the function with the modified data structure as an argument.

Next, some embodiments may determine whether the accessed instruction has a condition, like a conditional branch, as indicated by block 20. In some cases, this may include determining whether an instruction contains an operator that is conditional, like in equality operator, a non-equality operator, a while loop, a do-for loop, a greater-than operator, a less-than operator, a greater-than-or-equal-to operator, a less-than-or-equal-to operator, or the like.

Upon determining that the instruction does have a condition, some embodiments may determine whether the condition obtains (e.g., is satisfied), as indicated by block 22. In some cases, this operation may include obtaining operands associated with the instruction, like in a lower level of a hierarchy of the data structure associated with the operator, for instance, adjacent the operator in the hierarchy. In some cases, obtaining the operands may include executing a query specified by the operands, for instance, against a previously obtained API response or against an internal database. Some embodiments may evaluate whether the condition evaluates to true or false, which may include various ways of indicating a branch (e.g., like in a case statement, or indicating another iteration is to occur in a while loop).

Upon determining that the condition obtains, some embodiments may determine whether the condition specifies additional instructions, as indicated by block 24. For example, some embodiments may determine in block 22 to pursue a particular branch, and some embodiments may determine in block 24 whether that branch indicates additional instructions are to be added to the data structure. For example, some embodiments may include an instruction to parse an email address from every contact in a user's address book in a particular SaaS application, and some embodiments may determine in blocks 22 and 24 that the user has seven contacts and, thus, that twenty-one additional instructions are to be added, each additional instruction including a three transformations to be performed on the data describing the respective contact, like extracting and remapping a first name, extracting and remapping a last name, and extracting and remapping an email address. In another example, some embodiments may add instructions for each group in which the user belongs, each account the user holds, each instance of a given form of contact information (e.g., phone number, mailing address, email address, etc.), and the like. In some cases, for each of these instances, a set of instructions may be added, like an instruction to query an email address of a given contact, and another instruction to determine whether that email address is internal or external to an organization.

Next, some embodiments may add instructions to program state, as indicated by block 26. In some cases, this may include accessing the program state to which the initial instruction were loaded in the operation of block 14 to add more instructions. In some embodiments, the instructions may be added to a node of a hierarchy corresponding to the current instruction being executed. In other cases, the condition may specify that the added instructions are to be added to a different portion of the hierarchy, like for each, instance of an instruction satisfying some condition, such as an instruction operating upon a phone number, or an instruction operating on upon the particular field within a record corresponding to a group in a SaaS application. In some cases, adding instructions may include appending additional dictionary or list entries, adding attributes to objects, or adding additional entries in an associative array (which is not to imply that these categories are mutually exclusive, or the any other list of items contains exclusive categories).

As shown in process 10, other branches may be pursued. For example, block 20 indicates that, in some embodiments, if an instruction does not have a condition, some embodiments may execute the instruction and transform data fields, as indicated by block 30. In some cases, this may include associating a query result with a key that is the name of a field in an internal or external target data schema. In some cases, transforming data fields may include changing a format of a data field, for instance, by extracting portions of dates or addresses with regular expressions and combining those portions into an aggregate entry, or breaking up those portions into separate entries, each having different field names in the target data schema.

Similarly, program flow may turn to block 30 upon a negative result in the determination of block 24. For example, an instruction may indicate that if a particular condition obtains, a particular transformation is to be performed, and some embodiments may conditionally perform block 30 in that event.

Or in some cases, the condition may not obtain in block 22, and some embodiments may bypass operations 26, 24, and 30.

Next, some embodiments may determine whether there more instructions in the data structure, as indicated by block 32. In some cases, this may include determining that all instructions presently in the data structure have been executed, in which case, some embodiments may proceed to store or send the transform data, as indicated by block 28. In some cases, the data may be stored in a graph database, for instance in the case of inbound data, with the technique described below with reference to FIG. 2. Or in some cases, the data may be sent to a target network-accessible application, like a SaaS application, for instance via a REST-based API.

Alternatively, in some embodiments, if there are more instructions remaining in the data structure, some embodiments may return to block 18 and access the next instruction. In some cases, instructions may be added to a portion of the data structure that has already been traversed by a recursive function. In some embodiments, the recursive function may include a recursive sub-function that, or may itself, traverse the data structure in a depth-first or breadth-first traversal to identify these added instructions and cause them to be executed. In some cases, added instructions may cause additional instructions to be added, and this process may be repeated to arbitrarily large expansions of the initial instructions. In some cases, after a single iteration of the loop extending from block 18 to block 32, the data structure may contain more unexecuted instructions than when the iteration began. In some embodiments, the representation of the instructions in the data structure may grow based on the results of instructions being executed, changing the program itself by operation of the program based on the results of operations on or related to data being transformed. As a result, a relatively concise document may effectuate a relatively diverse set of operations that can accommodate a relatively diverse set of scenarios that may arise when transforming data between different data schemas.

FIG. 2 is a block diagram of a computing environment 230 in which the above-describe techniques may be implemented, though it should be emphasized that this is one example of a variety of different systems that are expected benefit from the presently described techniques.

As enterprises move their applications to the cloud, and in particular to SaaS applications provided by third parties, it can become very burdensome and complex to manage roles and permissions of employees. For example, a given business may have 20 different subscriptions to 20 different SaaS offerings (like web-based email, customer resource management systems, enterprise resource planning systems, document management systems, and the like). And that business may have 50,000 employees with varying responsibilities in the organization, with employees coming and going and changing roles regularly. Generally, the business would seek to tightly control which employees can access which SaaS services, and often which features of those services each employee can access. For instance, a manager may have permission to add or delete a defect-tracking ticket, while a lower-level employee may only be allowed to add notes or advance state of the ticket in a workflow. Or certain employees may have elevated access to certain email accounts or sensitive human resources related documents. Each time an employee arrives, leaves, or changes roles, different sets of SaaS user accounts may need to be added, deleted, or updated. Thus, many businesses are facing a crisis of complexity, as they attempt to manage roles in permissions across a relatively large organization using a relatively large number of SaaS services with relatively fine-grained feature-access controls.

These issues may be mitigated by some embodiments of the computing environment 230, which includes an identity management system 232 that manages roles and permissions on a plurality of different third-party SaaS applications 234 and 236. In some cases, the SaaS applications may be accessed by users having accounts and various roles, subject to various permissions, on user computing devices 238, 240, or 242, and those accounts may be managed by an administrator operating administrator computing device 244. In some cases, the user computing devices and administrator computing device may be computing devices operated by a single entity, such as a single entity within a single local area network or domain. Or in some cases, the user computing devices 238, 240, and 242 may be distributed among a plurality of different local area networks, for instance, within an organization having multiple networks. In the figure, the number of third-party application servers and user computing devices is two and three respectively, but it should be appreciated that commercial use cases are expected to involve substantially more instances of such devices. Expected use cases involve more than 10 third-party SaaS applications, and in many cases more than 20 or 50 third-party SaaS applications or on-premises applications. Similarly, expected use cases involve more than 1,000 user computing devices, and in many cases more than 10,000 or more than 50,000 user computing devices. In some cases, the number of users is expected to scale similarly, in some cases, with users transitioning into new roles at a rate exceeding 10 per day, and in many commercially relevant use cases, exceeding 100 or 1,000 per day on average. Similarly, versioning of third-party APIs and addition or subtraction of third-party APIs is expected to result in new APIs or new versions of APIs being added monthly or more often in some use cases.

In some embodiments, the user computing devices 238, 240, and 242 may be operated by users accessing or seeking access to the third-party SaaS applications, and administrator computing device 244 may be operated by a system administrator that manages that access. In some embodiments, such management may be facilitated with the identity management system 232, which in some cases, may automatically create, delete, or modify user accounts on various subsets or all of the third-party SaaS applications in response to users being added to, removed from, or moved between, roles in an organization. In some embodiments, each role may be mapped to a plurality of account configurations for the third-party SaaS applications. In some embodiments, in response to a user changing roles, the administrator may indicate that change in roles via the administrator computing device 244, in a transmission to the identity management system 232.

In response to this transmission, the identity management system may retrieve from memory and updated set of account configurations for the user in the new role, and records of these new account configurations may be created in a graph database in the identity management system 232. That graph database and the corresponding records may be synchronized with corresponding third-party applications 234 and 236 to implement the new account configurations, for instance, using the techniques described above. Further, in some cases, a new deployment of the identity management system 232 may contain a graph database populated initially by extracting data from the third-party SaaS applications and translating that data into a canonical format suitable for the graph database using the techniques described above. In some embodiments, the third-party SaaS applications may include an API server 260 and a web server 262.

In some embodiments, the computing environment 230 includes a data validator 228 that performs the operations of FIGS. 1 and 2 described above. In some cases, the data validator includes a document database storing the schemas described above, a schema formation module that performs the process 30 of FIG. 2, including a schema crawler that performs blocks 38 to 40 to recursively crawl through a set of linked schemas, and modules that combine criteria from the schemas. In some cases, the data validator 228 may validate data entering the identity repository 254 of the identity management system 232.

In some embodiments, the identity management system 232 may include a dynamic API server 229 that implements the process described above with reference to FIG. 1. In some embodiments, the dynamic API server 229 may receiving in-bound or out-bound data, identify the corresponding document (or constitute the document via references expressing inheritance and polymorphism), and perform the process 10 above to translate data between external data schemas and an internal data schema of the identity repository 254.

In some embodiments, each of the third-party SaaS applications are at different domains, having different subnetworks, at different geographic locations, and are operated by different entities. In some embodiments, a single entity may operate multiple third-party SaaS applications, for instance, at a shared data center, or in some cases, a different third-party may host the third-party SaaS applications on behalf of multiple other third parties. In some embodiments, the third-party SaaS applications may be geographically and logically remote from the identity management system 232 and each of the computing devices 238, 240, 242, and 244. In some embodiments, these components 232 through 242 may communicate with one another via various networks, including the Internet 246 and various local area networks.

In some embodiments, the identity management system 232 includes a controller 248, a data synchronization module 250, a rules engine 252, and identity repository 254, a rules repository 256, and a connector schema repository 258. In some embodiments, the controller 248 may direct the system 10 described above with reference to FIG. 1, e.g., via the task tree 16, in some cases by communicating with the various other modules of the identity management system and the other components of the computing environment 230. In some embodiments, the data synchronization module 250 may be configured to synchronize records in the identity repository 254 with records in the third-party SaaS applications, for instance by translating those records at the direction of the controller 248, using the system 10 of FIG. 1. For instance, a user may transfer into a sales group at a company, and the rules may indicate that in the new role, the user is be given a SaaS customer-relationship management account, and that account is to be added in the SaaS application to a group corresponding to a geographic sales region. These may lead to sequential tasks, where the account needs to be created via the API, before the API can be commanded to add the account to a group.

In some embodiments, the rules engine 252 may be configured to update the identity repository 254 based on rules in the rules repository 256 to determine third-party SaaS application account configurations based on changes in roles of users, for instance received from the administrator computing device 244, at the direction of controller 248. In some embodiments, the administrator computing device 244 may send a command to transition a user from a first role to a second role, for instance, a command indicating the user has moved from a first-level technical support position to a management position. In response, the controller 248 may retrieve a set of rules (which may also be referred to as a “policy”) corresponding to the former position and a set of rules corresponding to the new position from the rules repository 246. In some embodiments, these sets of rules may indicate which SaaS applications should have accounts for the corresponding user/role and configurations of those accounts, like permissions and features to enable or disable. In some embodiments, these rules may be sent to the rules engine 252, which may compare the rules to determine differences from a current state, for instance, configurations to change or accounts to add or remove. In some embodiments, the rules engine 252 may update records in the identity repository 254 to indicate those changes, for instance, removing accounts, changing groups to which users belong, changing permissions, adding accounts, removing users from groups, and the like. In some cases, applying the rules may be an example of unordered tasks performed by the system 10 above. In some embodiments, these updates may be updates to a graph data structure, like the examples described above. In some embodiments, the graph data structure may be a neo4j graph database available from Neo Technology, Inc. of San Mateo, Calif. In some embodiments, the controller 248 may respond to these updates by instructing the data sync module 252 translate the modified nodes and edges into API commands, using a variant of the system 10 of FIG. 1 send those API commands to the corresponding third-party SaaS applications.

In some embodiments, the identity repository 254 may include a graph data structure indicating various entities and relationships between those entities that describe user accounts, user roles within an organization, and the third-party SaaS applications. For instance, some embodiments may record as entities in the graph data structure the third-party SaaS applications, accounts of those applications, groups of user accounts (in some cases in a hierarchical taxonomy), groups of users in an organization (again, in some cases in a hierarchical taxonomy, like an organizational structure), user accounts, and users. Each of these nodes may have a variety of attributes, like the examples described above, e.g., user names for user accounts, user identifiers for users, group names, and group leaders for groups, and the like. In some embodiments, the graph data structure may be a neo4j graph database available from Neo Technology, Inc. of San Mateo, Calif.

In some embodiments, these nodes may be related to one another through various relationships that may be encoded as edges of the graph. For instance, an edge may indicate that a user is a member of a subgroup, and that that subgroup is a member of a group of subgroups. Similarly, and edge may indicate that a user has an account, and that the account is a member of a group of accounts, like a distribution list. In some examples, and edge may indicate that an account is with a SaaS application, with the respective edge linking between a node corresponding to the particular account and another node corresponding to the SaaS application. In some embodiments, multiple SaaS applications may be linked by edges to a node corresponding to a given party, such as a third-party.

In some embodiments, this data structure is expected to afford relatively fast operation by computing systems for certain operations expected to be performed relatively frequently by the identity management system 232. For instance, some embodiments may be configured to relatively quickly query all accounts of the user by requesting all edges of the type “has_an_account” connected to the node corresponding to the user, with those edges identifying the nodes corresponding to the respective accounts. In another example, all members of a group may be retrieved relatively quickly by requesting all nodes connected to a node correspond to the group by an edge that indicates membership. Thus, the graph data structure may afford relatively fast operation compared to many traditional systems based on relational databases in which such relationships are evaluated by cumbersome join operations extending across several tables or by maintaining redundant indexes that slow updates. (Though, embodiments are also consistent with use of relational databases instead of graph databases, as multiple, independently useful techniques are described).

Some embodiments of the identity management system implement techniques to translate between heterogenous APIs and a canoncial database, as described in a U.S. Patent Application titled MAPPING HETEROGENEOUS APPLICATION-PROGRAM INTERFACES TO A DATABASE, filed on the same day as this filing, bearing the attorney docket number 043979-0448279, the contents of which are hereby incorporated by reference.

Some embodiments of the identity management system may implement techniques to designate sets of tasks as sequential and execute them in sequence, while executing other tasks concurrently, as described in a U.S. Patent Application titled DISTRIBUTED PROCESSING OF MIXED SERIAL AND CONCURRENT WORKLOADS, filed on the same day as this filing, bearing the attorney docket number 043979-0448280, the contents of which are hereby incorporated by reference.

Some embodiments of the identity management system may implement techniques to organize schemas for a graph database within a set of hierarchical documents that define polymorphic schemas with inheritance described, as described in a U.S. Patent Application titled SCHEMAS TO DECLARE GRAPH DATA MODELS, filed on the same day as this filing, bearing the attorney docket number 043979-0448281, the contents of which are hereby incorporated by reference.

Some embodiments of the identity management system may implement techniques to process a dynamic API request that accommodates different contexts of different requests corresponding to different graph database schemas, as described in a U.S. Patent Application titled EXPOSING DATABASES VIA APPLICATION PROGRAM INTERFACES, filed on the same day as this filing, bearing the attorney docket number 043979-0448282, the contents of which are hereby incorporated by reference.

FIG. 5 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several techniques. Rather than separating those techniques into multiple isolated patent applications, the inventors have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the disclosed techniques to the particular form disclosed, but to the contrary, the intention is to cover all modifications, equivalents, and alternatives falling within the spirit and scope of the present disclosed techniques as defined by the appended claims. Further modifications and alternative embodiments of various aspects of the disclosed techniques will be apparent to those skilled in the art in view of this description. Accordingly, this description and the drawings are to be construed as illustrative only and are for the purpose of teaching those skilled in the art the general manner of carrying out the disclosed techniques. Elements and materials may be substituted for those illustrated and described herein, parts and processes may be reversed or omitted, and certain features of the disclosed techniques may be utilized independently, all as would be apparent to one skilled in the art after having the benefit of this description. Changes may be made in the elements described herein without departing from the spirit and scope of the disclosed techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs.

The present techniques will be better understood with reference to the following enumerated clauses:

1. A method of transforming data exchanged between a diverse set of target application program interfaces (APIs) having different respective external data schemas and an identity management system (IMS) database having an internal data schema with programs that adaptively expand their own set of instructions based on operation of the programs on API or IMS database responses, the method comprising: obtaining, with one or more processors, a document containing initial instructions to transform data entering or exiting an IMS, wherein: the instructions are to transform data between an internal data schema of an IMS database and a first data schema of a first API of a first network-accessible application providing resources to users, and the IMS database is configured to store records mapping the users to records of user accounts with a plurality of different network-accessible applications including the first network-accessible application; loading, with one or more processors, the initial instructions contained by the document into a data structure representing the initial instructions in program state; executing, with one or more processors, the initial instructions loaded into program state, wherein executing the instructions comprises: determining, based on data obtained from the first API or the IMS database, that a condition specified in at least some of the instructions is satisfied; in response to the determination, adding an additional instruction to the data structure in program state; and executing the additional instruction; based on results of executing the initial instructions and the additional instruction, transforming, with one or more processors, data between the internal data schema of the IMS database and the first data schema of the first API; and storing, with one or more processors, the transformed data in the IMS database or sending, with one or more processors, the transformed data to the first network-accessible application via the first API.
2. The method of embodiment 1, wherein the data structure and instructions therein evolve in the course of executing the instructions in the data structure to add additional instructions in response to results of executing some of the instructions already in the data structure, wherein a result of a given instruction causes a given added instruction to be added to the data structure and executed.
3. The method of any one of embodiments 1-2, wherein the instructions are executed in a depth-first recursive traversal of the data structure during which instructions are added to the data structure.
4. The method of any one of embodiments 1-3, wherein: some of the instructions yield a set of entries for a user and, in response to the set of entries, instructions pertaining to at least some of the entries are added to the data structure, the entries include contact information, groups, or accounts, and at least one instruction is added for each instance of contact information, for each group, or for each account in the set of entries.
5. The method of any one of embodiments 1-4, wherein: the obtained document is obtained in a hierarchical serialized data format encoding the initial instructions in an abstract syntax tree in text of the document; the initial instructions map a first plurality of dictionary keys to respective queries of a response of the first API, the response being obtained before at least some of the queries are applied to the response; the initial instructions map a second plurality of dictionary keys to respective queries of the IMS database; the first plurality and the second plurality of dictionary keys are values specified by the internal data schema; the transformed data augments records in the IMS database based on data accessed via the first API; the IMS database is a graph database having index free adjacency, wherein at least some nodes in the graph database correspond to users, at least some nodes of the graph database correspond to user accounts in a plurality of different network-accessible software-as-a-service applications, at least some edges of the graph database extend between nodes to indicate which users have which accounts; loading comprises parsing the document and adding a hierarchy of lists and dictionaries in which the initial instructions are arranged to form the data structure; executing the initial instructions comprises calling a function with the data structure as a parameter, wherein the function: performs a depth first traversal of the hierarchy of lists and dictionaries to determine next instructions to execute, causes at least some of the initial instructions to be executed, causes the data structure to be modified as a result of some of the instructions being executed, and recursively calls itself with the modified data structure as a parameter; executing the initial instructions further comprises: determining that a plurality of respective conditions obtain, wherein the plurality of conditions comprise: a determination that a result of one of the queries of the response of the first API is equal to a first value specified in the initial instructions; a determination that a result of one of the queries of the response of the first API is not equal to a second value specified in the initial instructions; and a determination that a result of one of the queries of the response of the first API satisfies a regular expression specified in the initial instructions; adding a plurality of additional instructions to the data structure; executing the plurality of additional instructions; transforming the data between the first API and the internal data schema of the IMS database comprises: replacing keys in key-value pairs obtained via the first API with keys specified by the internal data schema of the IMS database; combining data obtained via the first API with data obtained from the IMS database; forming an output hierarchical serialized data format document containing at least some of the results of executing the initial instructions and the additional instruction; storing the transformed data comprises: parsing the output hierarchical serialized data format document; and forming a plurality of commands in a query language of the graph database based on a result of parsing the output hierarchical serialized data format document; and adding entities or relationships between entities to the graph database with the plurality of commands; and the method comprises: transforming data exchanged between a diverse set of target application program interfaces (APIs) having different respective external data schemas and the IMS database with a plurality of homoiconic programs that adaptively expand themselves based on results of operations performed on API or database responses specified by the respective homoiconic programs.
6. The method of any one of embodiments 1-5, wherein obtaining a document containing initial instructions comprises: obtaining a document containing an abstract syntax tree representation of the instructions that makes structure of the abstract syntax tree explicit in text of the document.
7. The method of embodiment 6, wherein at least some of the instructions are encoded in the document in a plurality of levels of the hierarchy.
8. The method of any one of embodiments 1-7, wherein an operand of a given one of the instruction is encoded in the document at a first level of a hierarchy and an operator of the given one of the instructions is encoded in the document at a second level of the hierarchy.
9. The method of embodiment 8, wherein the first level is lower and adjacent the second level in the hierarchy.
10. The method of any one of embodiments 1-9, wherein loading the initial instructions comprises forming an associative array in, or as, the data structure, the associate array associating operators with both respective operands and outputs corresponding to branching results of the operators.
11. The method of embodiment 10, wherein at least some of the branching results including adding the additional instructions to the data structure.
12. The method of any one of embodiments 1-11, wherein operands of at least some of the instructions comprise a query in a query language operative to select nodes in a hierarchical data structure.
13. The method of any one of embodiments 1-12, wherein: obtaining the document containing initial instructions comprises steps for obtaining a document containing initial instructions; loading the initial instructions in the document into the data structure comprises steps for loading the initial instructions in the document into a data structure; and executing the initial instructions comprises steps for recursively executing instructions in a homoiconic domain-specific programming language.
14. The method of any one of embodiments 1-13, wherein: transforming the data comprises steps for transforming data; and storing the transformed data comprises steps for storing data in a graph database.
15. The method of any one of embodiments 1-14, comprising: obtaining another set of initial instructions to transform data between a second data schema of a second API of a second network-accessible application providing resources to users of the organization and the internal data schema of the IMS database; loading the other set of initial instructions into program state; executing the other set of initial instructions loaded into program state based on results of executing the other set of initial instructions, transforming data between the second data schema of the second API and the internal data schema of the IMS database.
16. The method of any one of embodiments 1-15, comprising: managing the user accounts with the plurality of different network-accessible applications with the IMS, wherein managing the user accounts comprises: receiving an indication that a given user has changed roles in the organization; accessing a policy repository of the IMS to identifying accounts for the given user to be changed; and effecting at least some of the changes by transforming the data between the first data schema of the first API and the internal data schema of the IMS database.
17. A system, comprising: one or more processors; and memory storing instructions that when executed by at least some of the processors effectuate operations comprising: the operations of any of clauses 1-16.
18. A tangible, non-transitory, machine-readable medium storing instructions that when executed by a data processing apparatus cause the data processing apparatus to perform operations comprising: the operations of any of clauses 1-16.

What is claimed is:

1. A method of transforming data exchanged between a diverse set of target application program interfaces (APIs) having different respective external data schemas and an identity management system (IMS) database having an internal data schema with programs that adaptively expand their own set of instructions based on operation of the programs on API or IMS database responses, the method comprising:
obtaining, with one or more processors, a document containing initial instructions to transform data entering or exiting an IMS, wherein:
the instructions are to transform data between an internal data schema of an IMS database and a first data schema of a first API of a first network-accessible application that provides resources to users, and
the IMS database is configured to store records mapping users to records of user accounts with a plurality of different network-accessible applications including the first network-accessible application;
loading, with one or more processors, the initial instructions contained by the document into a data structure representing the initial instructions in program state;
executing, with one or more processors, the instructions loaded into program state, wherein executing the instructions comprises:
determining, based on data obtained from the first API or the IMS database, that a condition specified in at least some of the instructions is satisfied,
in response to the determination, adding an additional instruction to the data structure in program state, and
executing the additional instruction;
at least in part by executing the initial instructions and the additional instruction, transforming, with one or more processors, data between the internal data schema of the IMS database and the first data schema of the first API; and
storing, with one or more processors, the transformed data in the IMS database or sending, with one or more processors, the transformed data to the first network-accessible application via the first API.

2. The method of claim 1, wherein the data structure and instructions therein evolve in the course of executing the instructions in the data structure to add additional instructions that were not previously present in the data structure in response to results of executing some of the instructions already in the data structure, wherein a result of a given instruction causes a given added instruction to be added to the data structure and be executed.

3. The method of claim 1, wherein the instructions are executed in a depth-first recursive traversal of the data structure during which instructions are added to the data structure.

4. The method of claim 1, wherein:
some of the instructions yield a set of entries for a user and, in response to the set of entries, instructions pertaining to at least some of the entries are added to the data structure,
the entries include contact information, groups, or accounts, and
at least one instruction is added for each instance of contact information, for each group, or for each account in the set of entries.

5. The method of claim 1, wherein:
the obtained document is obtained in a hierarchical serialized data format encoding the initial instructions in an abstract syntax tree in text of the document;
the initial instructions map a first plurality of dictionary keys to respective queries of a response of the first API, the response being obtained before at least some of the queries are applied to the response;
the initial instructions map a second plurality of dictionary keys to respective queries of the IMS database;
the first plurality and the second plurality of dictionary keys are values specified by the internal data schema;
the transformed data augments records in the IMS database based on data accessed via the first API;
the IMS database is a graph database having index free adjacency, wherein at least some nodes in the graph database correspond to users, at least some nodes of the graph database correspond to user accounts in a plurality of different network-accessible software-as-a-service applications, at least some edges of the graph database extend between nodes to indicate which users have which accounts;
loading comprises parsing the document and adding a hierarchy of lists and dictionaries in which the initial instructions are arranged to form the data structure;
executing the initial instructions comprises calling a function with the data structure as a parameter, wherein the function:
performs a depth first traversal of the hierarchy of lists and dictionaries to determine next instructions to execute,
causes at least some of the initial instructions to be executed,
causes the data structure to be modified as a result of some of the instructions being executed, and
recursively calls itself with the modified data structure as a parameter;
executing the initial instructions further comprises:
determining that a plurality of respective conditions obtain, wherein the plurality of conditions comprise:
a determination that a result of one of the queries of the response of the first API is equal to a first value specified in the initial instructions;
a determination that a result of one of the queries of the response of the first API is not equal to a second value specified in the initial instructions; and
a determination that a result of one of the queries of the response of the first API satisfies a regular expression specified in the initial instructions;
adding a plurality of additional instructions to the data structure;
executing the plurality of additional instructions;
transforming the data between the first API and the internal data schema of the IMS database comprises:
replacing keys in key-value pairs obtained via the first API with keys specified by the internal data schema of the IMS database;
combining data obtained via the first API with data obtained from the IMS database;
forming an output hierarchical serialized data format document containing at least some of the results of executing the initial instructions and the additional instruction;
storing the transformed data comprises:
parsing the output hierarchical serialized data format document; and
forming a plurality of commands in a query language of the graph database based on a result of parsing the output hierarchical serialized data format document; and
adding entities or relationships between entities to the graph database with the plurality of commands; and
the method comprises:
transforming data exchanged between a diverse set of target application program interfaces (APIs) having different respective external data schemas and the IMS database with a plurality of homoiconic programs that adaptively expand themselves based on results of operations performed on API or database responses specified by the respective homoiconic programs.

6. The method of claim 1, wherein obtaining a document containing initial instructions comprises:
obtaining a document containing an abstract syntax tree representation of the instructions that makes structure of the abstract syntax tree explicit in text of the document.

7. The method of claim 6, wherein at least some of the instructions are encoded in the document in a plurality of levels of the hierarchy.

8. The method of claim 1, wherein an operand of a given one of the instruction is encoded in the document at a first level of a hierarchy and an operator of the given one of the instructions is encoded in the document at a second level of the hierarchy.

9. The method of claim 8, wherein the first level is lower and adjacent the second level in the hierarchy.

10. The method of claim 1, wherein loading the initial instructions comprises forming an associative array in, or as, the data structure, the associate array associating operators with both respective operands and outputs corresponding to branching results of the operators.

11. The method of claim 10, wherein at least some of the branching results including adding the additional instructions to the data structure.

12. The method of claim 1, wherein operands of at least some of the instructions comprise a query in a query language operative to select nodes in a hierarchical data structure.

13. The method of claim 1, wherein:
obtaining the document containing initial instructions comprises steps for obtaining a document containing initial instructions;
loading the initial instructions in the document into the data structure comprises steps for loading the initial instructions in the document into a data structure; and
executing the initial instructions comprises steps for recursively executing instructions in a homoiconic domain-specific programming language.

14. The method of claim 1, wherein:
transforming the data comprises steps for transforming data; and
storing the transformed data comprises steps for storing data in a graph database.

15. The method of claim 1, comprising:
obtaining another set of initial instructions to transform data between a second data schema of a second API of a second network-accessible application providing resources to users of the organization and the internal data schema of the IMS database;
loading the other set of initial instructions into program state;
executing the other set of initial instructions loaded into program state
based on results of executing the other set of initial instructions, transforming data between the second data schema of the second API and the internal data schema of the IMS database.

16. The method of claim 1, comprising:
managing the user accounts with the plurality of different network-accessible applications with the IMS, wherein managing the user accounts comprises:
receiving an indication that a given user has changed roles in the organization;
accessing a policy repository of the IMS to identifying accounts for the given user to be changed; and
effecting at least some of the changes by transforming the data between the first data schema of the first API and the internal data schema of the IMS database.

17. A system, comprising:
one or more processors; and
memory storing instructions that when executed by at least some of the processors effectuate operations comprising:
obtaining a document containing initial instructions to transform data entering or exiting an identify management system (IMS), wherein:
the instructions are to transform data between an internal data schema of an IMS database and a first data schema of a first application program interface (API) of a first network-accessible application that provides resources to users, and
the IMS database is configured to store records mapping users to records of user accounts with a plurality of different network-accessible applications including the first network-accessible application;
loading the initial instructions contained by the document into a data structure representing the initial instructions in program state;
executing the instructions loaded into program state, wherein executing the instructions comprises:
determining, based on data obtained from the first API or the IMS database, that a condition specified in at least some of the instructions is satisfied,
in response to the determination, adding an additional instruction to the data structure in program state, and
executing the additional instruction;
at least in part by executing the initial instructions and the additional instruction, transforming data between the internal data schema of the IMS database and the first data schema of the first API; and
storing the transformed data in the IMS database or sending the transformed data to the first network-accessible application via the first API.

18. The system of claim 17, wherein the data structure and instructions therein evolve in the course of executing the instructions in the data structure to add additional instructions that were not previously present in the data structure in response to results of executing some of the instructions already in the data structure, wherein a result of a given instruction causes a given added instruction to be added to the data structure and be executed.

19. The system of claim 17, wherein the instructions are executed in a depth-first recursive traversal of the data structure during which instructions are added to the data structure.

20. The system of claim 17, wherein:
some of the instructions yield a set of entries for a user and, in response to the set of entries, instructions pertaining to at least some of the entries are added to the data structure,
the entries include contact information, groups, or accounts, and
at least one instruction is added for each instance of contact information, for each group, or for each account in the set of entries.

21. The system of claim 17, wherein obtaining a document containing initial instructions comprises:
obtaining a document containing an abstract syntax tree representation of the instructions that makes structure of the abstract syntax tree explicit in text of the document.
